(19) United States
(12) Patent Application Publication
(10) Pub. No.: US 2026/0145614 A1
(43) Pub. Date: May 28, 2026

(54) VEHICLE WITH CONTAINER STORAGE AND RETRIEVAL SYSTEM

(71) Applicant: FCA US LLC, Auburn Hills, MI (US)

(72) Inventors: Mark E Stout, Auburn Hills, MI (US); Travis D Bechtel, Auburn Hills, MI (US)

(21) Appl. No.: 18/958,768

(22) Filed: Nov. 25, 2024

(51) Int. Cl. B60R 5/02

(52) U.S. Cl. CPC B60R 5/02

(57) ABSTRACT

A vehicle includes a vehicle body that has a front compartment, a passenger compartment and a divider between the front compartment and the passenger compartment, the divider has an opening through which the front compartment and the passenger compartment are communicated, and a container handling system. The container handling system includes a movable arm arranged to engage a container that is within the front compartment and to move the container within the front compartment and relative to the opening to facilitate storage and retrieval of the container

### FIELD

The present disclosure relates to a vehicle with a container storage and retrieval system including a container handling system.

### BACKGROUND

Items left within a vehicle passenger compartment when the vehicle is not in use, or is used by a person other than the owner, for example a valet, are at risk of being stolen. Further, items stored within a cargo compartment of the vehicle that it outside of the passenger compartment, or that is spaced from occupants in the passenger compartment, are not accessible to a driver and storage space within the passenger compartment is limited.

### SUMMARY

In at least some implementations, a vehicle includes a vehicle body that has a front compartment, a passenger compartment and a divider between the front compartment and the passenger compartment, the divider has an opening through which the front compartment and the passenger compartment are communicated, and a container handling system. The container handling system includes a movable arm arranged to engage a container that is within the front compartment and to move the container within the front compartment and relative to the opening to facilitate storage and retrieval of the container.

In at least some implementations, the arm includes an end effector that is adapted to be selectively engageable with the container so that the container moves with the arm from one location in the front compartment to another location and so that the container can be released from the end effector to be placed in said another location.

In at least some implementations, a lift is adapted to move the container in a vertical direction, wherein the lift moves from a first position to a second position. In at least some implementations, the arm is movable in a plane that is perpendicular to the vertical direction. In at least some implementations, the arm includes multiple segments, and each segment is rotatable about a respective vertical axis, and the arm is arranged to move the container away from and to the lift when the lift is in the second position.

In at least some implementations, a track extending along at least part of the path, and which also includes an actuator associated with the track and adapted to cause movement of the container along the track, and wherein the track has an end arranged at the lift.

In at least some implementations, the divider includes a cover that is movable relative to the opening between a first position in which the cover permits the container to pass through the opening, and a second position in which the cover prevents the container from passing through the opening.

In at least some implementations, an instrument panel that defines or is coupled to the divider, and wherein the opening is located below the instrument panel.

In at least some implementations, an instrument panel that defines or is coupled to the divider, and wherein the opening extends through part of the instrument panel.

In at least some implementations, the arm includes multiple segments, and each segment is rotatable about a respective vertical axis, and the arm is arranged to move the container in a plane that is perpendicular to the vertical axes of the segments.

In at least some implementations, a shuttle coupled to the actuator so that the actuator causes movement of the shuttle along the track, wherein the shuttle is adapted to carry the container along the track, and the lift moves the shuttle and container when the lift moves from the first position to the second position.

In at least some implementations, a shuttle coupled to the actuator so that the actuator causes movement of the shuttle along the track, wherein the shuttle is adapted to carry the container along the track, and the lift moves the container relative to the shuttle when the lift moves from the first position to the second position.

In at least some implementations, the end effector is adapted to engage the container at or near a top of the container, and the end effector includes an actuator by which the container may be raised relative to the arm. In at least some implementations, the end effector includes one or more lift flanges that are movable and are adapted to be moved relative to a rim of the container to selectively engage and permit movement of the container by movement of the arm.

In at least some implementations, the arm includes a first segment that is connected to the vehicle body and a second segment that is connected to the first segment and extends from the first segment to a free end, and the first segment is longer than the second segment.

In at least some implementations, a vehicle a vehicle body, a path, a container and a container handling mechanism. The vehicle body has a front compartment, a passenger compartment and a divider between the front compartment and the passenger compartment, the divider having an opening through which the front compartment and the passenger compartment are communicated. The path extends through the opening and at least partly into the passenger compartment. The container is movable along the path between a first position in which the container is within the front compartment and a second position in which the container is received within the passenger compartment. The actuator is coupled to the container and operable to move the container along the path. The container handling system includes a movable arm arranged to engage the container within the front compartment and to move the container within the front compartment, the arm includes an end effector that is selectively engageable with the container so that the container moves with the arm from one location in the front compartment to another location and so that the container can be released from the end effector to be placed in said another location. The container handling system includes a lift arranged to move the container in a vertical direction, wherein the lift moves from a first position to a second position.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is an overhead view of part of the vehicle showing one or more storage containers in a cargo compartment;

FIG. 3 is a side view of part of the vehicle as in FIG. 2;

FIG. 4 is an overhead view of part of the vehicle showing one or more storage containers in a passenger compartment;

FIG. 5 is a side view of part of the vehicle as in FIG. 4;

FIG. 6 is a partial perspective view of a vehicle including a container handling system showing a lift of the container handling system in a first position.

FIG. 7 is a view similar to FIG. 6 showing the lift in a second position;

FIG. 8 is a view similar to FIGS. 6 and 7 and showing a container moved from the lift and into a storage area by an arm of the container handling system;

FIG. 9 is a front perspective view showing the arm moving a container within the storage area;

FIG. 10 is a view similar to FIG. 9 showing the arm and container in a different position to store one container near another container;

FIG. 11 is a side view showing an end effector and engager of the arm near a container; and

FIG. 12 is a view similar to FIG. 11 showing the engagers overlapped with a rim of the container to facilitate moving the container with the arm.

### DETAILED DESCRIPTION

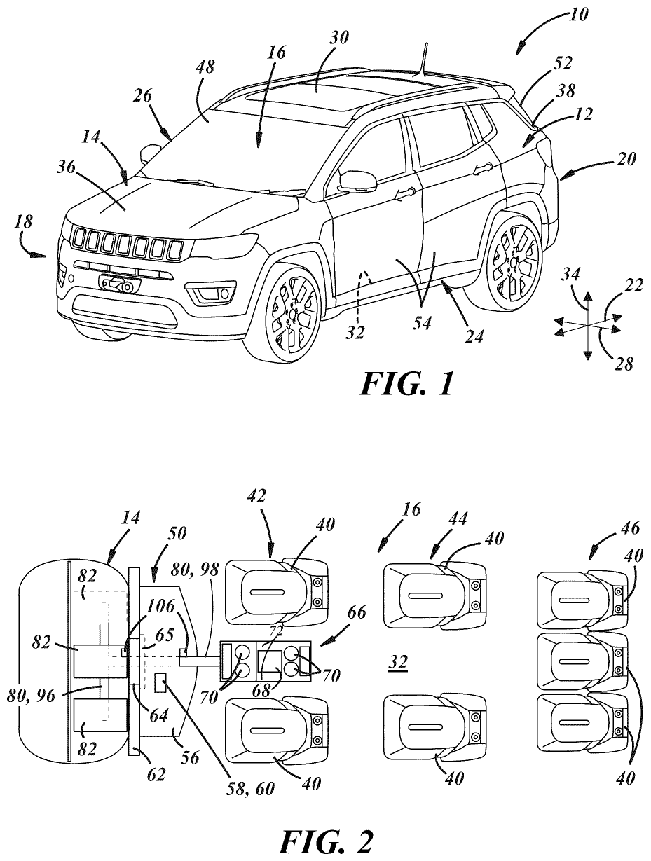

Referring in more detail to the drawings, FIG. 1 shows a vehicle 10 that includes a vehicle body 12 having a cargo compartment 14 and a passenger compartment 16. The vehicle 10 includes a front end 18 and a rear end 20 that are spaced apart in a fore-aft direction (shown by arrow 22), left and right sides 24, 26 that are spaced apart in a cross-car direction (shown by arrow 28), and a roof 30 and floor 32 that are spaced apart in a vertical direction (shown by arrow 34). The cargo compartment 14 may be separate from the passenger compartment 16 and typically is provided at one or both of the rear of the vehicle 10 (often called a trunk) and the front of the vehicle 10 (often called a front compartment 14 or frunk). A vehicle deck lid, such as a hood 36 or trunk lid 38 may define part of the cargo compartment 14, in at least some implementations. The deck lid is movable from a closed position to an open position to permit access to the area beneath the deck lid, which may include the cargo compartment 14. While not limited to electric vehicles, certain electric vehicles have considerable space available in the front compartment 14 or frunk and may be readily adapted for storage as noted herein.

Referring to FIGS. 2-5, the passenger compartment 16 is part or all of a vehicle interior and includes seats 40 for vehicle 10 occupants. In the example shown, a front row 42 of seats 40 includes two seats, e.g. for a driver and front passenger, a second row 44 with two seats 40 spaced apart in the cross-car direction, and a third row 46 having three seats 40. Any desired seating configuration may be used. The passenger compartment 16 may be defined at least in part by the roof 30 (e.g. interior headliner), floor 32, a windshield 48 (FIG. 1) and an instrument panel 50 at a front of the passenger compartment 16, a rear window 52 (FIG. 1) and/or body panel at a rear of the passenger compartment 16, and one or more doors 54 (FIG. 1) at the left and right sides 24, 26 of the vehicle 10, and associated vehicle structural components, such as pillars that extend to and are coupled to the roof.

The instrument panel 50 includes one or more interior trim pieces 56 and one or more displays 58 on which vehicle operational information is provided (e.g. gauges for speed, engine temperature and engine rpms, and icons for warning messages, etc.) and via which a human-machine interface (HMI) 60 may be provided. The HMI 60 may be part of an infotainment system by which various vehicle controls may be implemented or selected by a user, such as by a touch screen or other inputs like buttons or dials, and by which a remote device may be connected (e.g. a smart phone) and audio (e.g. radio/sound system) and other devices or systems may be accessed for user control. On or near the instrument panel 50, one or more drive controls may be provided, such as a steering input/wheel, a transmission/powertrain gear selector, an accelerator input and a brake input. The instrument panel 50 may define or be connected to a divider 62 that spans in the cross-car direction between the left and right sides 24, 26, in the vertical direction from the floor 32 to the windshield 48, and is located in the fore-aft direction between the cargo compartment 14 and the passenger compartment 16. The divider 62 may be, in at least some implementations, a structural member of the vehicle 10, sometimes called a firewall and may be used to separate powertrain components in the front compartment 14 from the passenger compartment 16 and to mount or passthrough various vehicle 10 components within the front compartment 14. The divider 62 may define at least part of the passenger compartment 16, in at least some implementations.

To permit at least selective communication between the cargo compartment 14 and the passenger compartment 16, an opening 64 is provided in the divider 62. The opening 64 may be located below the instrument panel 50 or through part of the instrument panel 50. In at least some implementations, a cover 65 is provided that is movable relative to the opening 64 to selectively close and open the opening 64.

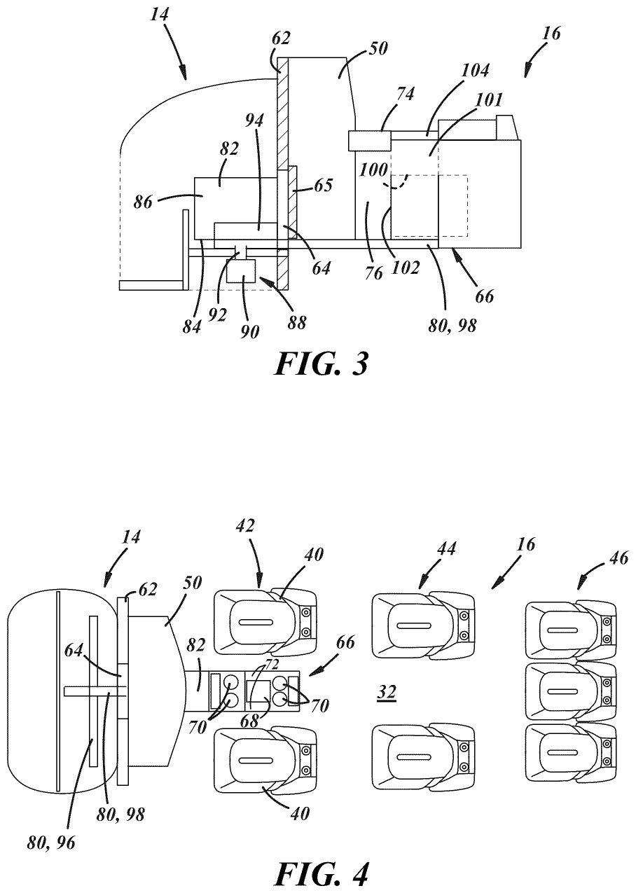

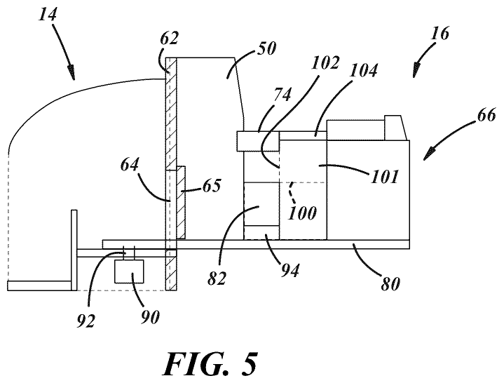

The vehicle 10 may include a console 66 that may, for example, have one or more storage compartments 68, one or more cupholders 70, an armrest 72 and other features or components as desired. The console 66 may be located between two seats 40, such as between the front two seats, as shown in FIGS. 2-5. In this arrangement, the console 66 may be generally centered in the cross-car direction and may be spaced from the instrument panel 50 in the fore-aft direction. The console 66 could be part of the instrument panel 50, or it may be coupled thereto by a bridge 74, such as is shown in FIGS. 3 and 5. The bridge 74 may provide some of the features noted (e.g. cupholders or storage areas) and may be spaced vertically from the floor 40 and arranged near an upper portion of the console 66. A space 76 (FIG. 3) may be provided between a lower surface of the bridge 74 and the floor 40, and things may be stowed in the space. Sidewalls or the like may be provided to contain items and keep the items out of footwells in front of the seats 40.

To contain stowed items and to facilitate moving items between the cargo compartment 14 and the passenger compartment 16, the vehicle 10 may include a container path 79 that extends through the opening and between the cargo compartment 14 and at least partly into the passenger compartment 14. A track 80 may be provided along at least part of the path 79, and the track may extend through the opening 64 and have part located in the cargo compartment 14 and/or part in the passenger compartment 16. The track 80 may be of any suitable construction and may be continuous or discontinuous along its length which may be oriented in the fore-aft direction. The track 80 may extend into the passenger compartment 16 and to, partly into or adjacent to the console 66. While shown as an elongated and generally flat member received on the floor of the vehicle 10, the track 80 may instead or in addition include sidewalls or guiderails spaced apart in the cross-car direction, such as a channel or the like.

To facilitate transferring things between the cargo compartment 14 and the passenger compartment 16, a container 82 is associated with the track 80 and is movable along the track 80. As shown in FIG. 3, the container 82 has a body which may include a bottom wall 84 and sidewalls 86 extending vertically from the bottom wall 84. The container 82 may be open at its upper end or closed, such as by a removable or movable cover or lid. Items may be placed in and contained by the container 82, and removed thereform, as desired. As shown in FIGS. 2 and 3, the container 82 has a first position in which the container 82 is located within the cargo compartment 14 and, as shown in FIGS. 4 and 5, a second position in which the container 82 is located within the passenger compartment 16. The container 82 may be of any suitable size and shape and is designed to pass through the opening 64 when it moves between the first and second positions, and the container 82 may be stopped between those positions in one or more intermediate positions, as desired.

The container 82 may be manually moved along the track 80 or the container 82 may be coupled to and driven by an actuator 88. In at least some implementations, the actuator 88 includes a motor 90 and a drive member 92 that is driven by the motor. For example, the motor 90 may be fixed in the vehicle 10, such as in the cargo compartment 14 or otherwise in the front compartment 14, and the motor 90 the drive member 92 may be a power transmission member, such as a belt, chain, cable or a screw which may be rotatable or stationary. The belt, chain, cable or screw (by way of non-limiting examples) may be driven by a gear or wheel that is rotated by the motor 90, or otherwise driven, as desired. To move the container 82, the container 82 may be coupled to the drive member 92 for movement as the drive member 92 moves. In at least some implementations, as shown in FIGS. 3 and 5, a shuttle or carrier 94 is provided that is coupled to the drive member 92, and the container 82 is connected to the carrier 94 so that both the carrier 94 and container 82 are driven by the motor 90. Other arrangements may be used, as desired. For example, the motor 90 may be carried by the container 82 and may directly rotate wheels coupled to the container 82 to move the container 82 relative to the vehicle 10. The wheels may move along the vehicle floor, or along the track 80, or both.

In at least some implementations, the container 82 may be movable within the cargo compartment 14 such that the container 82 has positions in which the container 82 is not aligned with the opening 64. That is, the container 82 may be offset in the cross-car direction, for example, from the opening 64. To facilitate such movement, as shown in FIGS. 2 and 4, the track 80 may include a second portion 96 that is received in the cargo compartment 14 and which guides and enables movement of the container 82 in the cross-car direction. In the example shown, the second portion 96 is provided at an end of the first portion 98, which extends into the passenger compartment 16. This lateral or cross-car movement of the container 82 can help to move the container 82 out of the center of the cargo compartment 14.

Additionally, the movement in a second direction enables more than one container 82 to be received in the cargo compartment 14, and selectively aligned with and movable through the opening 64, as shown in FIG. 2. In this way, a first container 82 may be moved in the cross-car direction out of the way of the opening 64 and spaced from the end of the first portion 98 of the track 80, to permit a second container 82 to be aligned with the opening 64 and ready for movement along the first portion 98 of the track 80 (e.g. into the passenger compartment 16). The second portion 96 of the track 80 may accommodate movement of a container 82 in one or both directions away from the opening 64 (e.g. toward the right and/or left sides of the vehicle 10). A separate actuator may be provided to move the containers 82 in the cross-car direction. The containers 82 may be moved along the second portion 96 on a carrier or shuttle 94, which may be arranged for movement along both the second portion 96 and the first portion 98 of the track 80, in a least some implementations. In this way, each container 82 may be received on a separate carrier or shuttle 94. The containers 82 may be releasable from the carriers or shuttles 94 and track 80 to permit the containers 82 to be removed from the vehicle 10, if desired.

In some implementations, the front compartment may have a floor that is lower than the level of the opening and a lifting mechanism may be used to raise the container(s) 82 from the level of the front compartment floor to the level of the opening. Non-limiting examples of lifting mechanisms include a scissor lift, screw mechanism, and the like. Mechanisms other than a motor and a track may be used to move the container(s) 82 within the front compartment, as desired.

To facilitate loading the containers 82 from within the passenger compartment 16 or retrieving items from the containers 82 from within the passenger compartment 16, in at least some implementations, the container 82 meshes or cooperates with the console 66. In the embodiment shown, and with reference to FIGS. 3 and 5, the console 66 includes a void 100 in a forward most or forward-facing side 102 of the console 66. When the container 82 is in the second position, the container 82 is received at least partially in the void 100. The container 82 may define part or all of a storage compartment of the console 66, and it may be accessed by opening a lid or cover 104 on the console 66 that overlies a console opening 101 or chamber leading to the void 100.

In at least some embodiments, the container 82 may be moved to the second position while the vehicle 10 is in use, to permit items to be stored in and retrieved from the console 66. This may occur automatically, if desired, when the vehicle 10 is turned on or otherwise set for use. Additionally, when the vehicle 10 is turned off or otherwise set for non-use, the container 82 may be moved into the cargo compartment 14 so that the container 82 and the contents therein are not accessible from within the passenger compartment 16. This may also be done automatically, if desired. Or this may be done as commanded by a user (e.g. via the HMI). This may be desirable to deter thieves from breaking into the passenger compartment 16 in search of items left in the passenger compartment 16.

In this regard, the cover 65 for the opening 64 may be closed other than when the container 82 is moving therethrough. The cover 65 may be opened manually, or automatically by an actuator. Proximity switches or sensors 106 (FIG. 2), for example, may be used to control movement of the cover 65 to permit a container 82 to pass through the opening 64 and to close the opening 64 after a container 82 moves through the opening 64. The cover 65 could be mechanically driven by movement of the container 82 relative thereto, if desired. By way of a non-limiting example, the container 82 may as it moves near the cover 65 displace a lever or cam that causes movement of the cover 65, and the system may be spring loaded to return to a starting position after such movement. Of course, other arrangements may be used, as desired, including arrangements with or without a cover and in which the container 82 blocks all or part of the opening. For example, when a container 82 is received within the front compartment, a surface of the container may be within the opening and block access to the interior of the container from within the passenger compartment. A cover or other component to block the opening may desirable for security reasons as well as for noise and environment isolation from the passenger compartment 16.

Further, the cargo compartment 14 may be fully enclosed or lockable such that opening the deck lid does not provide direct access to the cargo compartment 14 and containers 82. In this way, items may be stored securely when the vehicle 10 is not in use, or if the vehicle 10 is to be used by another person, for example without limitation, a valet who may drive the car to park it. Prior to giving the vehicle 10 to the valet (or other person), the container 82 may be moved into the cargo compartment 14. Further, the system can be set up to prevent others from commanding the container(s) 82 to move out of the cargo compartment 14, for example, by a lock/key or password/secure identification (e.g. fingerprint reader) type arrangement.

The systems provide a unique storage solution that enables easy transfer of things between a passenger compartment and a storage compartment. This may facilitate having more things accessible within the vehicle, such as with multiple containers that may be selectively brought into the passenger compartment. Increased security is also achievable by enabling stored items to be removed from the passenger compartment and located in a secure area outside of the passenger compartment when not needed, or when the vehicle is parked or might be driven by another person.

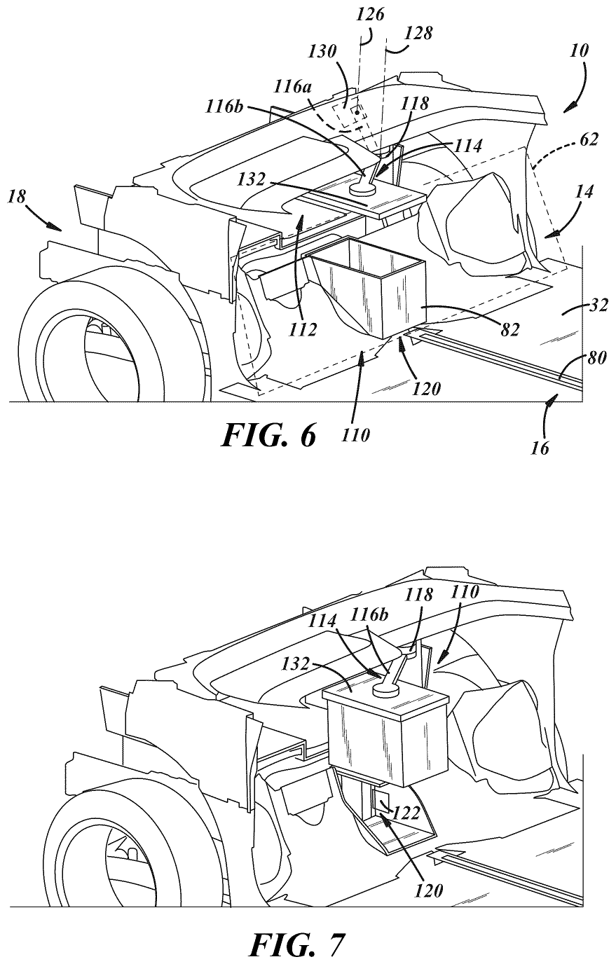

As shown in FIGS. 6-10, a container handling system 110 is provided to move the containers 82 into and within a container storage area 112 within the storage compartment 14. In this example, the storage area 112 is elevated from the floor 32 of the passenger compartment 16, and relative to the track 80 along which the containers 82 move. The elevated storage area 112 may be above components of the vehicle, such as the vehicle's front axle, steering gear, HVAC unit, and the like, which prevent the storage area 112 from being at the same level as the track 80 and vehicle floor 32. Accordingly, the system 110 includes one or more mechanisms arranged to raise a container 82 from the track 80, and to arrange multiple containers 82 within the storage area 112. In this way, without a person needing to arrange the containers 82, multiple containers 82 can be placed in and accessed from the storage compartment 14 in use of the vehicle 10.

The storage area 112 need not be elevated relative to the track 80 and could be on the same level, as generally described with reference to FIGS. 1-5. Further, the storage area 112 may be one continuous area or it may be partitioned or defined by multiple, separate storage areas 112 each arranged to receive one or more containers 82. One or more storage areas 112 may be accessed from outside the vehicle by, for example, opening the vehicle hood 36. Such storage areas 112 may include items not within a container 82 and separately stored in the storage area 112. One or more storage areas 112 may be inaccessible from outside the vehicle even with the hood 36 open, to discourage theft of items within such a storage area 112.

To facilitate moving a container 82 into and out of the storage area 112, in at least some implementations, the container handling system 110 includes one or more mechanisms which may be driven by one or more actuators, such as electric motors to selectively engage and move one or more containers 82. One mechanism may be an arm 114, which may be a “robotic arm”, that is movable in any desired direction to pick and place containers 82 from one location to another. The arm 114 may include multiple segments 116 that may be linked together at joints 118 that permit a desired degree of freedom and range of motion for each segment 116. In at least some implementations, the arm 114 can move vertically, to move containers 82 between the track 80 and the elevated storage area 112.

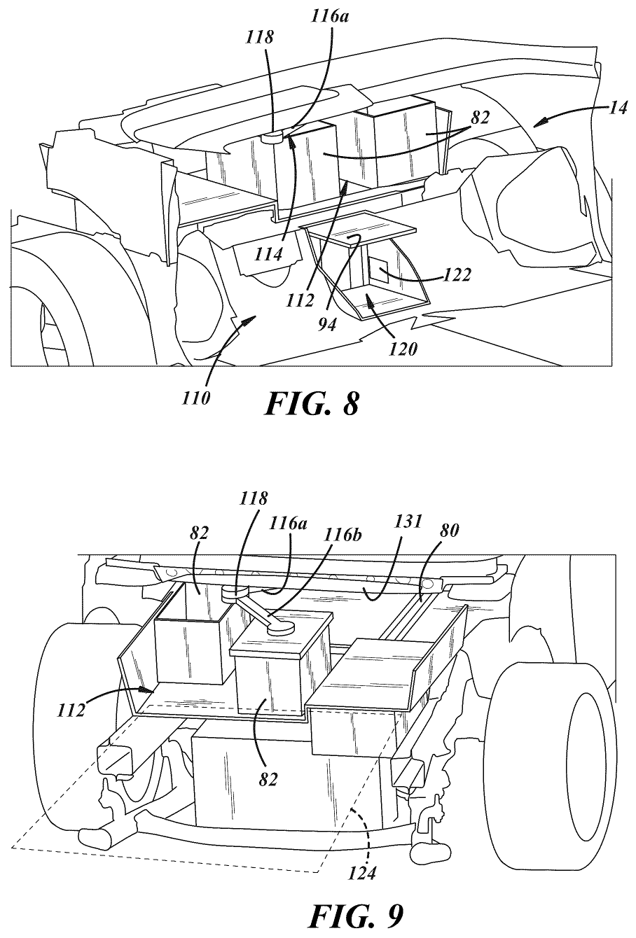

In the example shown in FIGS. 6-10, the container handling system 110 includes a lift 120 and an arm 114. The lift 120 includes a mechanism to vertically move the container 82, to raise the container 82 off the track 80 and to lower a container 82 onto the track 80. The lift 120 may engage the shuttle 94 and move the shuttle 94 relative to the track 80 along with a container 82 on the shuttle 94. Any suitable linear actuator 122 may be used to raise the container 82 and/or shuttle 94, such as, but not limited to a motor, pneumatic or hydraulic cylinder, ballscrew or the like which may directly move the lift or do so through a linkage or other drive arrangement, like a scissor-lift or other. The lift 120 may be received behind the divider 62 and has a first position ready to receive the shuttle 94, as shown in FIG. 6, and a second position, shown in FIGS. 7 and 8, raised from (e.g. vertically above) the first position to raise a shuttle 94 and/or container 82 from the track 80 and toward the elevated storage area 112. The path of travel of the lift 120 may be straight vertical, in at least some implementations, although other travel paths may be provided, as desired, to move containers 82 relative to one or more storage areas 112.

When a container 82 is moved by the lift 120 to the second position, the arm 114 can engage and move the container 82 away from the lift 120, as shown in FIGS. 7 and 8. In this example, the arm 114 does not move vertically and instead moves within a horizontal plane 124 (FIG. 8), generally parallel to the vehicle floor 32. This arm 114 includes two or more segments 116, with a first segment 116a and a second segment 116b shown in the illustrated examples. The segments 116a, 116b are connected together at a joint 118 that permits movement of the segments 116 relative to each other about respective vertical axes 126, 128 (FIG. 6) and are constrained against other movement. Further, the first segment 116a is connected/cantilevered at a base end to an actuator 130 and is movable relative to the actuator 130 and the vehicle about the vertical axis 126. The actuator 130 may be connected to a frame member 131 (FIG. 9) or other structural component of the vehicle body within the storage compartment. The connection to the frame member 131 or other component may be above a floor or lower surface of the storage area 112.

In the example shown, the first segment 116a is longer than the second segment 116b and rotates about the base axis 126 to provide sufficient reach or range of motion for container movement throughout all or most of the storage area(s) 112. The second segment 116b rotates about the second axis 128 that is parallel to the base axis 126 and provides additional range and the ability to move a container 82 closer to the base axis 126 than an end of the first segment 116a to which a first end of the second segment 116b is attached. That is, due to movement of the second segment 116b, the total arm length (e.g. distance from the base end of the first segment 116a) in different positions can be greater than or less than the length of the first segment 116a. This allows the second or free end of the second segment 116b to achieve a wide variety of positions and reach a wide range of locations in a storage area 112, while maintaining a very flat package (i.e. limited vertical height) that does not rely on vertical degrees of freedom, tracks or rails, a greater number of actuators, and the like. To permit containers 82 to be picked and placed by the arm 114, the second end of the second segment 116b carries or includes an end effector 132.

The end effector 132 is constructed and arranged to selectively engage and disengage from the containers 82, so the containers 82 can be picked up and moved, and placed down after movement. The end effector 132 may engage one or more sidewalls 86 of the containers 82, for example, and may also or instead engage a lid of the containers 82 in applications in which a lid is provided. In the example shown, for example in FIGS. 11 and 12, the end effector 132 includes a plate like member having one or more electrically actuated container engagers 134 that when closed grip part of the container 82 and when open do not grip and are released from the container 82. The engagers 134 have at least one movable portion that moves relative to the container 82. An engager 134 could clamp part of the container 82 between two surfaces, or move relative to the container 82 and selectively overlap a rim 136 or flange (e.g. from beneath the flange to permit lifting of a container 82 by the flange) or other engagement surface of the container 82 by way of non-limiting examples.

To permit the arm 114 to clear the top or upper edge 137 of the containers 82 and then engage and pick up a container 82, the engager 134 may include some vertical motion. In this way, the engager(s) 134 may move vertically relative to a container 82 when the end effector 132 is above a container 82 to selectively grab or let go of a container 82. This movement may be achieved in many ways. In one non-limiting example, shown in FIGS. 11 and 12, engagers 134 on opposite sides of the container 82 each include a lift flange 138 and are each rotated about separate axes 140 (FIG. 11) that are parallel and horizontally arranged. The lift flange 138 is vertically higher than the container 82 in a first position, and when the engagers 134 are rotated relative to the container 82, the lift flange 138 of each engager 134 is positioned partly beneath a respective container rim 136. In this example, the engagers 134 rotate in opposite directions about parallel and laterally/horizontally offset axes 140, and the lift flanges 138 are generally L-shaped, but other arrangements and shapes may be used, and the engagers 134 can instead clamp or trap portion of the container 82 as noted herein. Additionally, other mechanisms can be used to engage and move the containers, as desired. The mechanisms may use mechanical grippers, engagers, electromagnets, or other means, as desired.

FIGS. 6-10 illustrate a representative process for moving a container 82 from the passenger compartment 16 to the storage area 112 in the storage compartment 14. Referring first to FIG. 6, a container 82 may be moved in a first direction, shown as the fore-aft direction 22, along the track 80 through the opening 64 in the divider 62, until the container 82 reaches an end of the track 80. In this position, the container 82 is positioned below the storage area 112 and is registered and aligned with the lift 120 which is in the first position.

As shown in FIG. 7, the lift 120 is then actuated to move the lift 120 to the second position which raises the container 82 toward or two the level of the storage area 112. In the second position, the arm 114 is actuated to engage and enable movement of the container 82 away from the lift 120. To do this, the arm 114 is moved to position the end effector 132 over the container 82, as shown in FIG. 11, and then the end effector 132 is actuated to position the lift flanges 138 beneath the rim 136 of the container 82, as shown in FIG. 12. The lift flanges 138 may be rotated such that they engage the rim 136 and raise the container 82 off of the base of the lift 120 (or off of the shuttle 94 on which the container 82 moves along the track 80 as noted earlier). So arranged, the container 82 is clear of the lift 120, and the arm 114 can be actuated to laterally or horizontally move the container 82 away from the lift 120 (e.g. away from the base or shuttle 94), as can be seen by comparison of FIGS. 7 and 8.

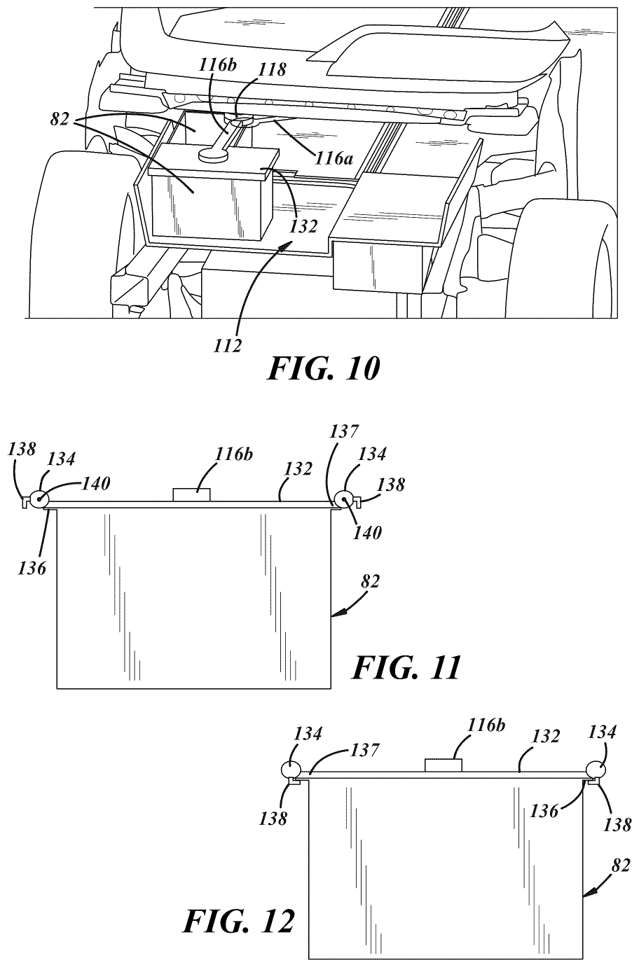

As shown in FIG. 8, the container 82 being moved into the storage area 112 can be moved to a position in which the container 82 is next to a second container 82. Or, as shown in FIGS. 9 and 10, the container 82 can be moved further into the storage area 112 to move the container 82 out of the path of travel of containers 82 to and from the lift 120. To reach the position shown in FIG. 9, the arm 114 is moved further away from the lift 120 so that the container 82 being moved is in front of the second container (e.g. between the second container and the front of the vehicle). To reach the position shown in FIG. 10, the arm 114 is manipulated to rotate the container 82 about a vertical axis and to move the container 82 to a side wall of the storage area 112. In this position, either the container 82 just moved or the second container 82 may be engaged by the arm 114 and moved to the lift 120 for subsequent lowering on the lift 120 and then movement into the passenger compartment 16.

Multiple containers 82 may be stored in one or more storage areas 112. The containers 82 may be separately moved within a storage area 112 and separately moved to and from the passenger compartment 16. Movement of the storage containers 82 to and within the storage compartment 14, storage area 112 and passenger compartment 16 may be controlled by a user via any desired means, such as but not limited to, a software application on a mobile device and/or the infotainment system or other HMI of the vehicle. User authentication or authorization may be required to enable use of the container handling system 110, to prevent unauthorized users from using the container handling system 110 to enable access to the container 82 and items stored therein. Any suitable authentication or authorization modes may be used, including but not limited to password, facial recognition, detection of a vehicle access device (e.g. key fob or authorized phone app) or other biometric recognition system (e.g. fingerprint, eye feature recognition and the like).

The containers 82 may be open top or closed top, may be heated or cooled (e.g. to store food and drink at desired temperature), may be lockable, and may be moved to secure areas to inhibit access to the container 82 even when a deck lid/hood 36 associated with the storage compartment 14 is open. The system can thus provide a wide range of utility to occupants of a vehicle.

For example, during daily use the users of a vehicle often have need to store a diverse array of objects in the vehicle. In an internal combustion engine powered vehicle, the locations available for item storage include large designated cargo areas in the rear of the vehicle (such as the trunk or space behind the rearmost row of seats), small designated cargo areas (such as the center console or glove box), or the footwell/seat cushion of unoccupied seating areas.

Storing items in each of these locations comes with unique problems/challenges. Items stored in the trunk are not accessible to any vehicle occupants, and items stored behind the rearmost row of seats are out of reach for at least occupants in more forward rows of seats. As such, stored items can only be accessed by being passed forward by rear occupants, or by way of the driver stopping the vehicle and leaving their seating position to access these items. Additionally, items stored behind the rearmost row of seats are also visible from outside the vehicle, presenting a tempting target for smash and grab thieves.

Storage areas 112 in easy reach of the front row occupants such as center consoles, glove boxes, door pockets, etc., improve access by front row occupants, but are limited in their size and thus, the scope of items that can be stored in them. Front row occupants may also be inclined to use the passenger footwell as a workaround storage location (or the passenger seat if there is only a driver in the vehicle), however items stored in this way are not secured and are thus susceptible to moving around and tipping over.

As noted herein, rear-engine and battery-powered vehicles may also add a front storage area (Frunk or sometimes referred to as a ZIF or “Zone-in-front”) that can be used to store items in the space forward of the cabin, as noted herein. Frunk or “ZIF” cargo compartments are often large enough to store a wide variety of items. These items are not visible from outside the vehicle, offering protection from theft while the vehicle is unoccupied. However, the user must get out of the passenger compartment 16 of their vehicle to store or access items from this location, meaning that they are not accessible to the occupants of the vehicle while in motion.

The systems described herein enable a wide range of items to be stored in the passenger compartment 16 and the storage compartment 14, and enable movement of items between the compartments to greatly increase the utility of and access to items within the vehicle. These items can include, but are not limited to, food and drinks, electronic devices, personal valuables, purses/bags, trash, and many others. Users of a vehicle may have need to access these items during various stages of a journey, or to store these items securely and out of the way when they are not needed or when occupants are finished with them (as in the case of trash or empty food containers 82). The system described here provides users of a vehicle with a way to store items out of the way when they are not needed by keeping them in the storage area outside of the passenger compartment 16, while allowing users the ability to easily access the items when they are needed and while the vehicle is in use.

What is claimed is:

1. A vehicle, comprising:
a vehicle body having a front compartment, a passenger compartment and a divider between the front compartment and the passenger compartment, the divider having an opening through which the front compartment and the passenger compartment are communicated; and
a container handling system including a movable arm arranged to engage a container that is within the front compartment and to move the container within the front compartment and relative to the opening to facilitate storage and retrieval of the container.

2. The vehicle of claim 1 wherein the arm includes an end effector that is adapted to be selectively engageable with the container so that the container moves with the arm from one location in the front compartment to another location and so that the container can be released from the end effector to be placed in said another location.

3. The vehicle of claim 1 which includes a lift adapted to move the container in a vertical direction, wherein the lift moves from a first position to a second position.

4. The vehicle of claim 3 wherein the arm is movable in a plane that is perpendicular to the vertical direction.

5. The vehicle of claim 4 wherein the arm includes multiple segments, and each segment is rotatable about a respective vertical axis, and the arm is arranged to move the container away from and to the lift when the lift is in the second position.

6. The vehicle of claim 3 which also includes a track extending along at least part of the path, and which also includes an actuator associated with the track and adapted to cause movement of the container along the track, and wherein the track has an end arranged at the lift.

7. The vehicle of claim 1 wherein the divider includes a cover that is movable relative to the opening between a first position in which the cover permits the container to pass through the opening, and a second position in which the cover prevents the container from passing through the opening.

8. The vehicle 1 which also includes an instrument panel that defines or is coupled to the divider, and wherein the opening is located below the instrument panel.

9. The vehicle of claim 1 which also includes an instrument panel that defines or is coupled to the divider, and wherein the opening extends through part of the instrument panel.

10. The vehicle of claim 1 wherein the arm includes multiple segments, and each segment is rotatable about a respective vertical axis, and the arm is arranged to move the container in a plane that is perpendicular to the vertical axes of the segments.

11. The vehicle of claim 6 which also includes a shuttle coupled to the actuator so that the actuator causes movement of the shuttle along the track, wherein the shuttle is adapted to carry the container along the track, and the lift moves the shuttle and container when the lift moves from the first position to the second position.

12. The vehicle of claim 6 which also includes a shuttle coupled to the actuator so that the actuator causes movement of the shuttle along the track, wherein the shuttle is adapted to carry the container along the track, and the lift moves the container relative to the shuttle when the lift moves from the first position to the second position.

13. The vehicle of claim 2 wherein the end effector is adapted to engage the container at or near a top of the container, and the end effector includes an actuator by which the container may be raised relative to the arm.

14. The vehicle of claim 13 wherein the end effector includes one or more lift flanges that are movable and are adapted to be moved relative to a rim of the container to selectively engage and permit movement of the container by movement of the arm.

15. The vehicle of claim 10 wherein the arm includes a first segment that is connected to the vehicle body and a second segment that is connected to the first segment and extends from the first segment to a free end, and the first segment is longer than the second segment.

16. A vehicle, comprising:
a vehicle body having a front compartment, a passenger compartment and a divider between the front compartment and the passenger compartment, the divider having an opening through which the front compartment and the passenger compartment are communicated;
a path extending through the opening and at least partly into the passenger compartment;
a container movable along the path between a first position in which the container is within the front compartment and a second position in which the container is received within the passenger compartment;
an actuator coupled to the container and operable to move the container along the path; and
a container handling system including a movable arm arranged to engage the container within the front compartment and to move the container within the front compartment, the arm includes an end effector that is selectively engageable with the container so that the container moves with the arm from one location in the front compartment to another location and so that the container can be released from the end effector to be placed in said another location, and the container handling system includes a lift arranged to move the container in a vertical direction, wherein the lift moves from a first position to a second position.

17. The vehicle of claim 16 wherein the arm includes multiple segments, and each segment is rotatable about a respective vertical axis, and the arm is arranged to move the container in a plane that is perpendicular to the vertical axes of the segments.

18. The vehicle of claim 17 wherein the arm includes a first segment that is connected to the vehicle body and a second segment that is connected to the first segment and extends from the first segment to a free end, and the first segment is longer than the second segment.

19. The vehicle of claim 16 wherein the end effector engages the container at or near a top of the container, and the end effector includes an actuator by which the container may be raised relative to the arm.

20. The vehicle of claim 19 wherein the end effector includes one or more lift flanges that are movable relative to a rim of the container to selectively engage and permit movement of the container by movement of the arm.
